(19) United States
(12) Patent Application Publication
(10) Pub. No.: US 2007/0043738 A1
(43) Pub. Date: Feb. 22, 2007

(54) Methods and systems for reputation based resource allocation for networking

(75) Inventors: Dirk A. Morris, San Carlos, CA (US); John D. Irwin, San Francisco, CA (US); Robert B. Scott, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metavize, Inc., San Mateo, CA (US)

(21) Appl. No.: 11/349,589

(22) Filed: Feb. 7, 2006

Related U.S. Application Data
(60) Provisional application No. 60/651,097, filed on Feb. 7, 2005.

(51) Int. Cl. G06F 17/30

(52) U.S. Cl. 707/10

(57) ABSTRACT

A method and system for reputation-based resource allocation for networking. The present invention provides a method for determining an allocation of a plurality of computer resources based on a reputation factor for each of the one ore more clients. Clients associated with bad reputation factors may be denied or delayed from computer resources. According to an embodiment, the method is used in a computer network environment wherein one or more clients share a plurality of computer resources. The method includes a step of providing a network appliance. The network appliance includes one or more memories and a central processing unit. The networking appliance has at least a first port and a second port. The first port and the second port exchanges a stream of information. The network appliance is characterized by a limited quantity of system resources. The method also includes a step for processing the stream of network traffic.

### CROSS-REFERENCES TO RELATED APPLICATIONS

This application claims priority to the Provisional Application No. 60/651,097 filed Feb. 7, 2005, commonly assigned and hereby incorporated by reference for all purposes.

### BACKGROUND OF THE INVENTION

This invention relates to computer network systems. In particular, the More particularly, the present invention provides a technique, including a method and system, for monitoring and allocating resources on a computer network system. As merely an example, the present invention is implemented on a wide area network of computers or workstations such as the Internet. But it would be recognized that the present invention has a much broader range of applicability including local area networks, a combination of wide and local area networks and the like.

Telecommunication techniques have been around for numerous years. In the early days, people such as the American Indians communicated to each other over long distances using “smoke signals.” Smoke signals were generally used to transfer visual information from one geographical location to be observed at another geographical location. Since smoke signals could only be seen over a limited range of geographical distances, they were soon replaced by a communication technique known as telegraph. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

In the 1990s, another significant development in the telecommunication industry occurred. People began communicating to each other by way of computers, which are coupled to the telephone lines or telephone network. These computers or workstations coupled to each other can transmit many types of information from one geographical location to another geographical location. This information can be in the form of voice, video, and data, which have been commonly termed as “multimedia.” Information transmitted over the Internet or Internet “traffic” has increased dramatically in recent years. In fact, the increased traffic has caused congestion, which leads to problems in responsiveness and throughput. This congestion is similar to the congestion of automobiles on a freeway, such as those in Silicon Valley from the recent “boom” in high technology companies, including companies specializing in telecommunication. As a result, individual users, businesses, and others have been spending more time waiting for information, and less time on productive activities. For example, a typical user of the Internet may spend a great deal of time attempting to view selected sites, which are commonly referred to as “Websites,” on the Internet. Additionally, information being sent from one site to another through electronic mail, which is termed “email,” may not reach its destination in a timely or adequate manner. In effect, quality of service or Quality of Service (“QoS”) of the Internet has decreased to the point where some messages are being read at some time significantly beyond the time the messages were sent.

Quality of Service is often measured by responsiveness, including the amount of time spent waiting for images, texts, and other data to be transferred, and by throughput of data across the Internet, and the like. Other aspects may be application specific, for example, jitter, quality of playback, quality of data transferred across the Internet, and the like. Three main sources of data latency include: the lack of bandwidth at the user (or receiving) end, the general congestion of Internet, and the lack of bandwidth at the source (or sending) end.

A solution to decreasing data latency includes increasing the bandwidth of the user. This is typically accomplished by upgrading the network link, for example by upgrading a modem or network connection. Another way to decreasing data latency includes creasing the bandwidth at the source end. The latter solution has its limitation. For instance, a source cannot indefinitely increase its bandwidth, as a source may be limited by various constraints such as bandwidth, processing power, memory, etc. At certain instances, requests from users for system resource can exceed the total amount of resource available at the source. For example, when too many users request for a web page, the source for the web page does not have sufficient processing power and bandwidth to handle all of the user requests. Under such situation, a system must how to allocate resources and what actions to take. For example, the system may decide to ignore, delay, or reject a request from a user to preserve the resource.

To ensure that each of the users accessing a network is allocate a proper amount of resource from a source, which is limited my various abovementioned constraints, various techniques have been used. For example, some conventional systems allocate network resource on a first-come-first-server basis. At some other instances, some convention systems allocate network resources based on a global or per-client limit. Unfortunately, convention techniques as described above are often inadequate for many of the network applications. These and other limitations of the conventional techniques have been overcome, at least in part, by the invention that has been fully described below.

Therefore, it is desirable to have an improved method and system for allocating resources on a network.

### BRIEF SUMMARY OF THE INVENTION

This invention relates to computer network systems. In particular, the More particularly, the present invention provides a technique, including a method and system, for monitoring and allocating resources on a computer network system. As merely an example, the present invention is implemented on a wide area network of computers or workstations such as the Internet. But it would be recognized that the present invention has a much broader range of applicability including local area networks, a combination of wide and local area networks and the like.

According to certain embodiments of the present invention, a reputation shield is used for reputation-based resource allocation, where past client behavior considered when determining the allocation of network resources. For example, the reputation shield provides racking of client behavior and using this information to allocate system resources to requests in a more efficient manner. According to an embodiment, the reputation shield shields computer systems from excessive requests for server resources which can occur under attack, abuse or aggressive usage. Under these circumstances, the reputation shield accepts requests from well behaved clients, and limits requests from ill behaved clients.

According to an embodiment, the present invention provides a method for determining an allocation of a plurality of computer resources based on a reputation factor for each of the one ore more clients. For example, more computer resources are allocated to clients with good reputation factors. Clients associated with bad reputation factors may be denied or delayed from computer resources. According to an embodiment, the method is used in a computer network environment wherein one or more clients share a plurality of computer resources. The method includes a step of providing a network appliance. The network appliance includes one or more memories and a central processing unit. The networking appliance has at least a first port and a second port. The first port and the second port exchanges a stream of information. The network appliance is characterized by a limited quantity of system resources (e.g., memory, network bandwidth, CPU usage, etc.). The method also includes a step for processing the stream of network traffic. The stream of network traffic includes a first plurality of activities associated with a first client. The first client is coupled to a world wide area of network of computers. The method also includes a step for storing a first set of attributes associated with the first plurality of activities associated with the first client. Additionally, the method includes a step for obtaining a first formula for determining a first reputation factor associated for the first client. The method also includes a step for obtaining a first computation factor for determining the first reputation factor associated for the first client. In addition, the method includes a step for determining the first reputation factor for the first client based on the first set of attributes and the first computation factor using the first formula. The reputation factor includes a numerical value. The method additionally includes a step for receiving a request for a quantity of the limited system resources from the first client. The method also includes a step for determining a usage of the computer resources. Additionally, the method includes a step for determining an allocation of the quantity of limited system resources associated with the first client based on the reputation factor. Moreover, the method includes a step for maintaining a reserve allocation of the quantity of limited resources for a second request from a second client.

According to an another embodiment, the present invention provides a system for determining an allocation of the plurality of network resources based on a reputation factor for each of the one ore more clients. For example, the system is used in a computer network environment wherein one or more clients share a plurality of network resources (e.g., memory, a network bandwidth). The system includes a network interface that is configured to receive and send information from the one or more clients over the computer network environment. The network interface includes a first port and a second port. The system also includes a reputation database configured to store at least one reputation factor. The at least one reputation factor is determined based on a plurality of activities associated with a first client. The system additionally includes a configuration database for storing a plurality of configuration information. According to an embodiment, the plurality of configuration information includes a first formula for determining the at least one reputation factor. Additionally, the system includes a delegator configured to allocate the plurality of network resources based on the first reputation factor. The delegator maintains a reserve allocation of the quantity of limited resources for a second request from a second client.

According to another embodiment, the present invention provides a method for processing a stream of data. The method includes a step for providing a network appliance. The network appliance includes one or more memories and a central processing unit. The networking appliance also includes at last a first port and a second port. The first port and the second port are configured to exchange a stream of information. The network appliance is characterized by a limited quantity of system resources. The method includes providing a hierarchy (e.g., a trie structure that stores recording according to a logical structure). The hierarch includes a first node, which is associated with a first portion of a network. The first nodes includes a first reputation factor. The first portion of the network includes a second portion. The method includes a step for identifying a second node, the second node being associated with the second portion. The method also includes a step for associating the second node to the first node. In addition, the method includes a step for providing a second reputation factor for the second node. The second reputation factor is the same as the first reputation if the second node is free from a reputation factor. Moreover, the method includes a step for allocating a plurality of resources for the second node based on the second reputation factor.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating a reputation shield in a computer network system according to an embodiment of the present invention.

FIG. 2 is a simplified diagram illustrating a trie for storing reputation factors according to an embodiment of the present invention.

FIG. 3 is a simplified diagram illustrating the creation of a node at a trie according to an embodiment of the present invention.

### DETAILED DESCRIPTION OF THE INVENTION

This invention relates to computer network systems. In particular, the More particularly, the present invention provides a technique, including a method and system, for monitoring and allocating resources on a computer network system. As merely an example, the present invention is implemented on a wide area network of computers or workstations such as the Internet. But it would be recognized that the present invention has a much broader range of applicability including local area networks, a combination of wide and local area networks and the like.

As described above, various conventional techniques have been used for allocating resource on a computer network. For example, some conventional systems allocate network resource on a first-come-first-serve basis. At some other instances, some convention systems allocate network resources based on a global or per-client limit. While conventional techniques offer some way to allocate resource, these techniques are often inefficient and unfair. This is because conventional techniques generally considers very little of—if at all—client behaviors and the hierarchal topology of the network. For example, under the first-come-first-serve scheme, a spammer may have higher priority over a valid client for the network resource.

In addition to inefficient allocation of network resources, poor allocation of network resource sometimes result in halting a network system. For example, a network appliance that is used to a process network traffic generally has limit resource. According to an embodiment, a network appliance is implemented using a general purpose computer. According to another example, a network appliance is implemented using an application specific integrated circuit (ASIC). For example, the network appliance has limited CPU power, memory, and network bandwidth. As another example, the network appliance is limited by the number of network sessions. In the present invention, a session means a virtual connection that links these hosts and determines how they communicate. For example, one computer starts the session, then other hosts join and leave over time. When the last computer leaves the session, the session ends and the network layer is torn down. A session often consumes a large amount of memory for the network appliance. The meaning of session is broadly defined and is not limiting. When too many clients send requests to the network appliance, the network appliance can crash and hang up the network system.

It is to be appreciated, therefore, that the present invention provides a method for allocating resource based on both the previous behavior of clients and hierarchical topology of the network. According to certain embodiments, the present invention provides a reputation shield for reputation based resource allocation. For example, a reputation shield is used to track client behaviors and use this information to allocate system resource to requests in more efficient manner. According to an embodiment, the reputation shield is use to protect a network system from excessive requests for server resources which can occur under attack, abuse or aggressive usage. For example, the reputation shield accepts requests from well behaved clients, and limits requests from ill behaved clients. As a result, the reputation shield is a new heuristic for allocating system resources to the most desirable clients.

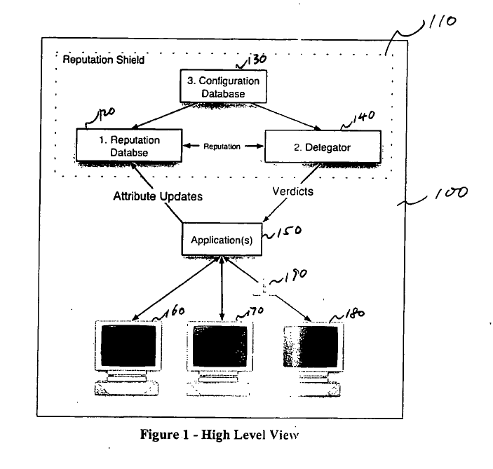

According to an embodiment, the reputation shield is implemented in three components. FIG. 1 is a simplified diagram illustrating a reputation shield in a computer network system according to an embodiment of the present invention. This diagram is merely an example, which should not unduly limit the scope of the claims. One of ordinary skill in the art would recognize many variations, alternatives, and modifications. As illustrated on FIG. 1, a computer network 100 includes a reputation shield 110 that is connected to an application interface 150, and the application interface 150 is connected to a clients 160, 170, and 180. The reputation shield 100 includes three components: a reputation database 120, a configuration database 130, and a delegator 140.

The three components of the reputation shield 100 are connected to one another to perform various functions. The reputation database 120 models and monitors client behaviors. The delegator 140 distributes system resources based on the information collected from the reputation database 120. The configuration database 130 provides configuration as to how the reputation database 120 and delegator 140 operate. The structure of reputation shield 100 merely provides an example according to an embodiment. One of ordinary skill in the art would recognize many variations, alternatives, and modifications. For example, a reputation shield 100 may be implemented as a single unit that performs the functions of three component. According to an embodiment of the present invention, a network appliance that handles network traffics includes all three components. Alternatively, two of three components may be a single unit (e.g., the delegator 140 and the configuration database as a single unit, etc) according to certain embodiments.

When a client computer, such as 160, requests for resource to perform certain tasks, the client computer goes through the application interface 150. The application interface 150 queries the delegator 140 for advice on how to proceed and update the reputation database 120 to create and maintain an accurate reputation factor, which may simply be a number according to certain embodiments, for that particular client computer. Generally, the operations of the delegator 140 and the reputation database 120 does not require much resource.

The reputation database 120, collects a number of metrics about the requests and resource usage of particular clients, called attributes. For example, when the client computer 160 requests for resource, the reputation database 120 collects attributes related to resourced used associated with the request. According to an embodiment, attributes are related to the parameters that are closely associated with resource usage such as the number of connection requests, bandwidth usage, active sessions, memory usage, etc. When the client makes a new request for more resources, the appropriate attributes are accordingly updated.

According to an embodiment, attributes associate with a client are enclosed by a attribute vector. For example, an attribute vector contains numerical values for the number of connection requests, bandwidth usage, active sessions, and memory usage. For determining the reputation factor for the client, a mathematical formula and a matrix are used in conjunction with the attribute vector. For example, the matrix has the same form factor as the attribute factor, and a reputation factor is obtains by obtain the dot product (multiple the appropriate values and summing these values) of the attribute factor and the matrix.

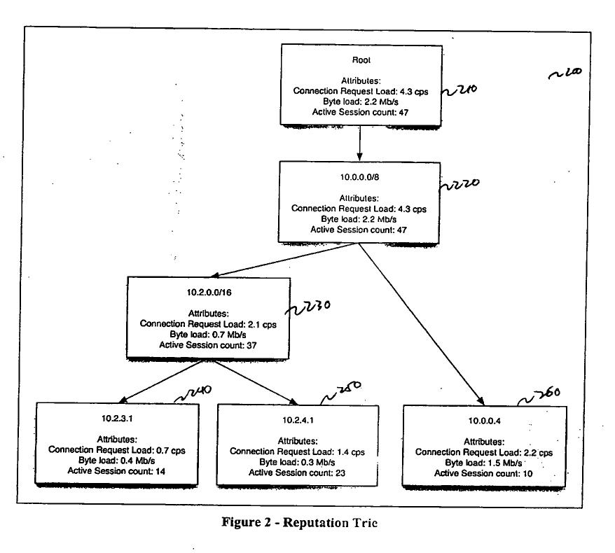

In a network environment, it is often desirable to track the behavior of multiple clients and store the tracked behavior according one or more hierarchies. For example, clients from a single Internet service provider may be grouped together. In addition, organizing clients makes it easier to summarize group behavior of clients. According to certain embodiments, the present invention enables the reputation database to track behavior groups of clients as well as individual clients by organizing reputation factors in a trie data structure as shown in FIG. 2.

FIG. 2 is a simplified diagram illustrating a trie for storing reputation factors according to an embodiment of the present invention. This diagram is merely an example, which should not unduly limit the scope of the claims. One of ordinary skill in the art would recognize many variations, alternatives, and modifications. A trie 200 includes nodes at various levels. At the top most level, the trie 200 includes a root node 210 that represents the resource usage of all clients. The leaf nodes 240, 250, and 250 respectfully represent individual clients. The intermediate nodes 220 and 230 represent behavior of subnets.

Now referring back to FIG. 1, the reputation shield 110 determines whether to grant a client access to network resources when the network is under heavy load. For example, the reputation database 120 indicates that the client 180 has poor reputation factor. As a result, when the computer network 100 is under heavy load or being overloaded, the reputation shield 110 declines to grant network resources to the client 180. For example, the reputation shield 110 decides that network resources to a client 160 instead.

Under certain situations, it is insufficient to determine the allocation of network resource based on individual clients. For example, when the network 100 is under heavy load, the reputation shield 110 needs to determine how to allocate network resources to clients. However, if a new client (a client that does not have a reputation factor stored at the reputation database 110) requests for network resource when the network is under heavy load, the reputation shield 110 does not have information to make a decision as to how to allocate network resources. It is therefore to be appreciated that according certain embodiments of the present invention a trie data structure, which stores reputation factors in a hierarchical manner, enables the reputation shield to determine the allocation of resource to a new client based on a “group” reputation factor associate with that new client.

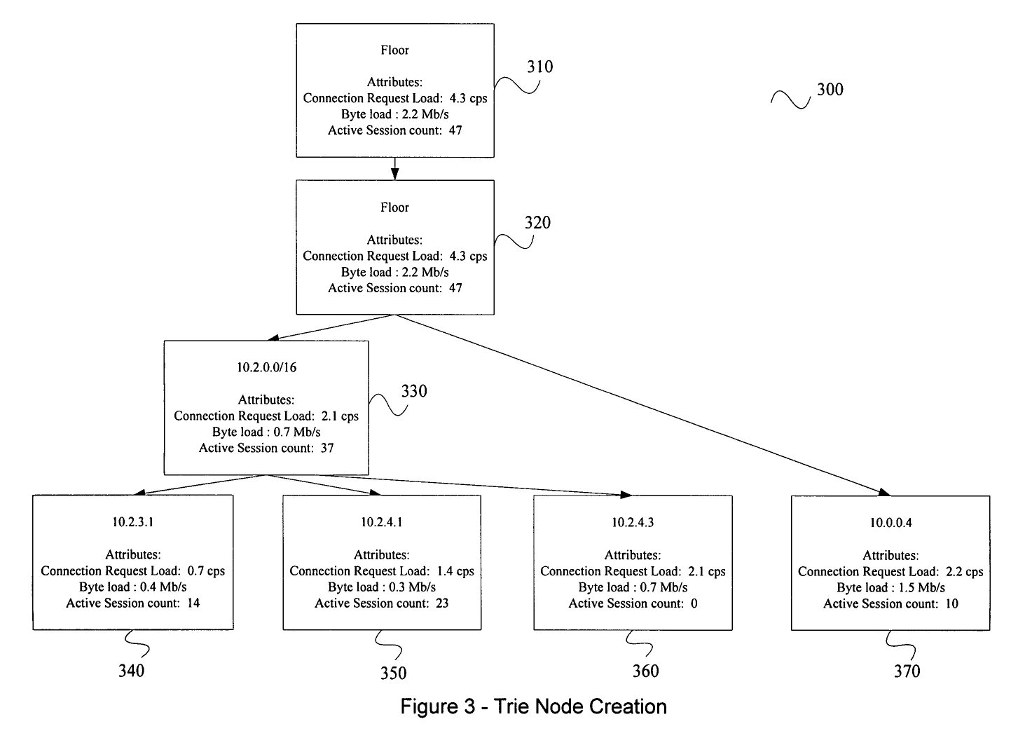

FIG. 3 is a simplified diagram illustrating the creation of a node at a trie according to an embodiment of the present invention. This diagram is merely an example, which should not unduly limit the scope of the claims. One of ordinary skill in the art would recognize many variations, alternatives, and modifications. As illustrated on FIG. 3, a trie 300 includes a root node 310 and three leaf nodes 340, 350, and 370. The leaf node 360 is associated with a new client. Because the new client access the computer network for the first time, the reputation database does have any reputation factors for this new client. However, as can be seen on FIG. 3, the new client can be place under the intermediate node 330. As merely an example, the new client is place under the intermediate node 330 because the new client has an IP address of “10.2.4.3”, which shares the “10.2.#.#” IP as the intermediate node 300. According to an embodiment, the new client inherits a reputation factor from the intermediate node 330, and the inherit reputation factor for the new client is stored at leaf node 360. As merely an example, the new client may be allocated the same resource as other leaf nodes (leaf nodes 340 and 350) under the intermediate node 330. It is to be appreciated that the ability to inherit a reputation factor from a group by a new client is helpful in preventing network spams. For example, the intermediate node 330 stores a reputation factor that reflects distribute DOS attaches. The new client under the intermediate node 330 can be prevented from accessing the network for the inherited reputation factor that indicates poor reputation factor (for the spamming activities) from the intermediate node 330.

Now referring back to FIG. 1. The reputation shield 110 includes a delegator 140. According to an embodiment, the delegator 140 uses a delegation model to determine the allocation of network resources. For example, the delegation model is used to decide when resources are nearing the limit and how they should be allocated.

According to an embodiment, the delegator 140 first determines how close the system is to its resource limit by examining the hard limits imposed by the network appliance. For example, the configuration database 130 stores limits for appropriate attributes for particular applications. As an example, the configuration database 130 has a hard limit for a network application based on the maximum numbers of session and maximum throughput. In addition, other attributes, such as CPU and memory usage, can be used for setting limits. To accommodate network traffics, the delegator dynamically modifies the hard limits. For example, as network traffic becomes congested, the delegator imposes a harder limit, and only clients that have relatively good reputation factors are allowed to use the resource. According to certain embodiments, some resources (such as CPU usage or bandwidth) can be limited gradually, while some have a verdict (discrete decisions), like session creation which can be allowed, denied, delayed, challenged, etc.

According to an embodiment, the delegator works in conjunction with a configuration database. For example, the delegator obtains a function from the configuration database, and applies the current state of the system (based on available resources) and the client reputation as inputs. The function often takes the inputs and calculate a number, which when plotted on a curve will define which verdict to return. In addition, the function is capable of using other method to compute the verdict.

The delegator is invoked by the application at the time of a resource request. The delegator generally looks at the available resources and the reputation and returns a verdict to the application. The application then takes that verdict and enforce it in the appropriate manner.

According to an embodiment, the delegator and the reputation database work together with the configuration database. The configuration database maintains all of the information that controls the way the reputation database and delegator operate. The reputation shield generally operates with a variety of different applications. In order to accomplish this goal, the delegator and the reputation database are implemented in such a way that they retrieve all application specific parameters and functionalities from the configuration database.

Now referring to FIG. 1. During an operation, the reputation database 120 queries the configuration database to determine which attributes to track and how to update and calculate them. According to an embodiment, the configuration database determines how attributes are collected. For example, for some attributes such as connection requests and CPU usage, a time weighted average is more important than static values. For attributes like the number of active sessions, it is important to monitor a static value that changes over time. Other attributes, like overall CPU load, do not require any calculation, but are queried from the operating system. According to an embodiment, the reputation database 120 and configuration database 130 share a common interface for describing how to handle each attribute, as there are many different ways to track attributes. When the reputation shield configuration is modified, the reputation database 120 queries all of the attributes to monitor and how to monitor each one from the configuration database 130. This allows the reputation database function to work with a wide range of applications.

According to an embodiment, the configuration database 130 determines how the delegator 140 interprets information from the reputation database. For example, certain verdicts only make sense for certain applications, and some attributes being monitored are not be pertinent to certain applications. According to an embodiment, the configuration database 130 provides a function for describing how to interpret the statistics from the behaviors database for each application. For example, when an application makes a request to the delegator 140, the delegator 140 determines a response based on the function from the configuration database. This function takes two inputs: the attribute vector and a representation of the current resource usage. Using these inputs, the function calculates a verdict for the request.

It is be appreciated that the present inventions provide a wide range of applications. According to an embodiment, the present invention is used to offer SYN flood protection in a transparent proxy. According to another embodiment, the present invention provides a solution for virus scanning on an SMTP server. Depending on various embodiments, there are other applications as well.

According to an embodiment, the present invention is used to offer SYN flood protection in a transparent proxy. SYN (synchronize) is a type of packet used by the Transmission Control Protocol (TCP) when initiating a new connection to synchronize the sequence numbers on two connecting computers. A SYN is acknowledged by a SYN/ACK by the responding computer. For example, a client may send a SYN to the server on a network, and the server respond the SYN Protection from SYN flooding is a difficult problem in systems that can not use SYN cookies (the traditional solution). This is true for transparent proxies, which can not prematurely return a SYN/ACK because the server may not exist. This breaks the transparency and some applications will repeatedly try to connect to a server that is not present and flood the system. Often it is required to accept the SYN and setup state for the session and connect to the server before returning the SYN/ACK to the client, or return a RST or DROP if the server is not present. This opens the possibility of SYN floods as the proxy must perform many actions based on a single SYN.

According to an embodiment, the reputation shield is invoked at the time of the receipt of a SYN. As merely an example, a verdict can come back as “ACCEPT”, “COOKIE”, “DROP”, or “RESET”. An “ACCEPT” verdict means the system has plenty of resources and the connection will proceed along the normal state diagram. A “COOKIE” verdict means to use a SYN cookie on this session exclusively. This will break transparency for only this session, which does not break many applications. This also makes sure the request is real and not spoofed, as the client must first response with an ACK before any further action is taken. A “DROP” verdict means to drop the SYN, which will be retransmitted later, hopefully when the system has more available resources. A “RESET” verdict tells the client that the resource is not available.

It is to be appreciated that according to an embodiment, the present invention effectively mitigates SYN floods. If someone is performing a spoofed SYN flood, the root node reputation in the reputation database will become bad enough that all new clients will get verdicts of COOKIE or worse. This means that a SYN cookies will be used for new clients while remaining fully transparent for existing clients with good reputations. If the SYN flood is not being spoofed, that client's reputation will move first into COOKIE, and if they answer the SYN/ACKs, eventually into DROP and RESET.

According to another embodiment, the present invention provides a solution for virus scanning on an SMTP server. Virus and Spam scanning on a high output SMTP email server is a difficult problem. Virus and Spam scanning generally takes large amounts of CPU. When the system becomes saturated, work piles up and performance falls off a cliff.

It is to be appreciated that according to an embodiment, the present invention provides a reputation shield that controls the rate of email so the system remains productive. As an analogy, the reputation shield works like lights on highway onramps used during rush hour. According to an embodiment, the delegator can return a “ACCEPT”, “PRIORITY”, “DELAY”, or “DROP” verdict. The Delegator first checks available CPU, bandwidth and the client reputation. If there is plenty of resources, the delegator returns an “ACCEPT” verdict and the SMTP server continues. The delegator can also return a “PRIORITY” verdict, which is not a discrete verdict, but also contains a number. The application then uses this priority to perform the respective task according to the given priority. If the system is under moderate load, it returns a “DELAY” verdict, which will cause the SMTP server to delay for a number of seconds before trying again. If the system is highly loaded, an email can be dropped in response to a “DROP” verdict. The sender of the email retries at a later time so no email is lost.

According to an embodiment, the present invention provides a method for determining an allocation of a plurality of computer resources based on a reputation factor for each of the one ore more clients. For example, more computer resources are allocated to clients with good reputation factors. Clients associated with bad reputation factors may be denied or delayed from computer resources. According to an embodiment, the method is used in a computer network environment wherein one or more clients share a plurality of computer resources. The method includes a step of providing a network appliance. The network appliance includes one or more memories and a central processing unit. The networking appliance has at least a first port and a second port. The first port and the second port exchanges a stream of information. The network appliance is characterized by a limited quantity of system resources (e.g., memory, network bandwidth, CPU usage, etc.). The method also includes a step for processing the stream of network traffic. The stream of network traffic includes a first plurality of activities associated with a first client. The first client is coupled to a world wide area of network of computers. The method also includes a step for storing a first set of attributes associated with the first plurality of activities associated with the first client. Additionally, the method includes a step for obtaining a first formula for determining a first reputation factor associated for the first client. The method also includes a step for obtaining a first computation factor for determining the first reputation factor associated for the first client. In addition, the method includes a step for determining the first reputation factor for the first client based on the first set of attributes and the first computation factor using the first formula. The reputation factor includes a numerical value. The method additionally includes a step for receiving a request for a quantity of the limited system resources from the first client. The method also includes a step for determining a usage of the computer resources. Additionally, the method includes a step for determining an allocation of the quantity of limited system resources associated with the first client based on the reputation factor. Moreover, the method includes a step for maintaining a reserve allocation of the quantity of limited resources for a second request from a second client. For example, the method for determining an allocation of a plurality of computer resources is implemented according to FIGS. 1-3.

According to an another embodiment, the present invention provides a system for determining an allocation of the plurality of network resources based on a reputation factor for each of the one ore more clients. For example, the system is used in a computer network environment wherein one or more clients share a plurality of network resources (e.g., memory, a network bandwidth). The system includes a network interface that is configured to receive and send information from the one or more clients over the computer network environment. The network interface includes a first port and a second port. The system also includes a reputation database configured to store at least one reputation factor. The at least one reputation factor is determined based on a plurality of activities associated with a first client. The system additionally includes a configuration database for storing a plurality of configuration information. According to an embodiment, the plurality of configuration information includes a first formula for determining the at least one reputation factor. Additionally, the system includes a delegator configured to allocate the plurality of network resources based on the first reputation factor. The delegator maintains a reserve allocation of the quantity of limited resources for a second request from a second client. For example, the system for determining an allocation of the plurality of network resources is implemented according to FIGS. 1-3.

According to another embodiment, the present invention provides a method for processing a stream of data. The method includes a step for providing a network appliance. The network appliance includes one or more memories and a central processing unit. The networking appliance also includes at last a first port and a second port. The first port and the second port are configured to exchange a stream of information. The network appliance is characterized by a limited quantity of system resources. The method includes providing a hierarchy (e.g., a trie structure that stores recording according to a logical structure). The hierarch includes a first node, which is associated with a first portion of a network. The first nodes includes a first reputation factor. The first portion of the network includes a second portion. The method includes a step for identifying a second node, the second node being associated with the second portion. The method also includes a step for associating the second node to the first node. In addition, the method includes a step for providing a second reputation factor for the second node. The second reputation factor is the same as the first reputation if the second node is free from a reputation factor. Moreover, the method includes a step for allocating a plurality of resources for the second node based on the second reputation factor. For example, the method for processing a stream of data is implemented according to FIGS. 1-3.

It is to be appreciated that the present invention provides a method for allocating resource based on both the previous behavior of clients and hierarchical topology of the network. According to certain embodiments, the allocation of resource based on clients previous behavior, as illustrated and explained above, offers an efficient and fair way of allocating network resources.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. In a computer network environment wherein one or more clients share a plurality of computer resources, a method for determining an allocation of the plurality of computer resources based on a reputation factor for each of the one ore more clients comprising:
providing a network appliance including one or more memories and a central processing unit, the networking appliance having at least a first port and a second port, the first port and the second port exchanging a stream of information, the network appliance being characterized by a limited quantity of system resources;
processing the stream of network traffic including a first plurality of activities associated with a first client, the first client being coupled to a world wide area of network of computers;
storing a first set of attributes associated with the first plurality of activities associated with the first client;
obtaining a first formula for determining a first reputation factor associated for the first client;
obtaining a first computation factor for determining the first reputation factor associated for the first client;
determining the first reputation factor for the first client based on the first set of attributes and the first computation factor using the first formula, the reputation factor comprising a numerical value;
receiving a request for a quantity of the limited system resources from the first client;
determining a usage of the computer resources;
determining an allocation of the quantity of limited system resources associated with the first client based on the reputation factor; and
maintaining a reserve allocation of the quantity of limited resources for a second request from a second client.

2. The method of claim 1 wherein the first port and the second port is the same port.

3. The method of claim 1 further comprising updating the first set of attributes in response to a second plurality of activities associated with the first client.

4. The method of claim 1 wherein the plurality of computer resources comprises network bandwidth.

5. The method of claim 1 wherein the plurality of computer resources comprises new session initiation rate.

6. The method of claim 1 wherein the plurality of computer resources comprises a plurality number of sessions.

7. The method of claim 1 wherein the plurality of computer resources comprises processing power.

8. The method of claim 1 wherein the plurality of computer resources comprises a memory.

9. The method of claim 1 further comprising using a trie to prevent DOS attacks associated with a plurality of attackers from a same group.

10. The method of claim 1 wherein the first computation factor comprises a first matrix, the first matrix including a plurality of weights.

11. The method of claim 1 further comprising associating the first client to a first group.

12. The method of claim 11 further comprising determining a second reputation factor associate with the first group.

13. The method of claim 1 further comprising determining the first reputation factor into a trie data structure.

14. The method of claim 1 wherein the determining the allocation of the plurality computer resources comprises determining a verdict.

15. The method of claim 1 wherein the determining the first reputation factor is based on a hierarchy topology of the computer network.

16. In a computer network environment wherein one or more clients share a plurality of network resources, the plurality of network resources including a memory and a network bandwidth, a system for determining an allocation of the plurality of network resources based on a reputation factor for each of the one ore more clients comprising:
a network interface configured to receive and send information from the one or more clients over the computer network environment, wherein the network interface including a first port and a second port;
a reputation database configured to store at least one reputation factor, wherein the at least one reputation factor is determined based on a plurality of activities associated with a first client;
a configuration database for storing a plurality of configuration information, the plurality of configuration information including at least a first formula for determining the at least one reputation factor;
a delegator configured to allocate the plurality of network resources based on the first reputation factor, wherein the delegator maintains a reserve allocation of the quantity of limited resources for a second request from a second client.

17. The system of claim 16 wherein the first port and the second port is the same port.

18. A method for processing a stream of data, the method comprising:
providing a network appliance including one or more memories and a central processing unit, the networking appliance having at last a first port and a second port, the first port and the second port exchanging a stream of information, the network appliance being characterized by a limited quantity of system resources;
providing a hierarchy, the hierarch includes a first node, the first node being associated with a first portion of a network, the first portion of the network includes a second portion, the first node including a first reputation factor;
identifying a second node, the second node being associated with the second portion;
associating the second node to the first node;
providing a second reputation factor for the second node, the second reputation factor being the same as the first reputation if the second node is free from a reputation factor; and
allocating a plurality of resources for the second node based on the second reputation factor.

19. The method of claim 18 wherein the first port and the second port is the same port.
